(19) United States
(12) Patent Application Publication
(10) Pub. No.: US 2019/0180279 A1
(43) Pub. Date: Jun. 13, 2019

(54) METHOD AND SYSTEM FOR REFUND MANAGEMENT WITH ONGOING INSTALLMENTS

(71) Applicant: Mastercard International Incorporated, Purchase, NY (US)

(72) Inventor: Sagitha GEORGE, Harrow (GB)

(73) Assignee: Mastercard International Incorporated, Purchase, NY (US)

(21) Appl. No.: 15/837,524

(22) Filed: Dec. 11, 2017

(51) Int. Cl. G06Q 20/40; G06Q 20/22; G06Q 20/38; G06Q 20/10

(52) U.S. Cl. CPC G06Q 20/407; G06Q 20/102; G06Q 20/389; G06Q 20/29

(57) ABSTRACT

A method for processing refunds for ongoing installment transactions includes: storing an account profile including an account number and current balance; storing installment profiles, each including the account number and a remaining balance; receiving a transaction message indicative of a refund that includes a plurality of data elements including the account number, a refund amount, and a flag indicating the refund is for an installment transaction; updating the remaining balance in at least one installment profile, wherein a difference between a combination of the remaining balance and the updated remaining balance for each installment profile is less than or equal to the refund amount; and updating the current balance in the account profile by increasing the current balance when the refund amount is greater than the difference between the combination of the remaining balance and the updated remaining balance for each of the at least one installment profile.

### FIELD

The present disclosure relates to the processing of refunds for ongoing installments, specifically the refunding of one or more issuer-funded installments as a result of a refund of the same or a separate issuer-funded installment.

### BACKGROUND

For large purchases, consumers have often been interested in ways to be able to receive an item immediately that is not paid off until a later date. For some items, financing options are available via loans, mortgages, or other similar mechanisms, such as often found when purchasing vehicles or homes. For smaller ticket items, consumers can often use credit cards, where the issuing institution will pay the merchant immediately for a purchase and the consumer will pay back the issuer for all such purchases made over a period of time. In some countries, merchants have also begun to participate in deferred payment plans, selling products to consumers via installments, where a consumer can purchase a product for a down payment and make regular, periodic payments to the merchant to cover the remaining cost of the product.

However, installments may not be available for all merchants. The implementation of installments for a merchant may require significant computing resources and expenditures, and also require the merchant to be able to repossess a product or take other recourse if an installment payment is not received. In some cases, a consumer may want to purchase a product from such a merchant, but only have the income suitable for purchasing the product by installments. In these cases, issuing institutions have begun to offer installments, referred to herein as issuer-funded installments. In issuer-funded installments, a single transaction is turned into an installment where the single transaction is replaced by a number of transactions that are applied to the issued transaction account over a period of time, typically at regular intervals. This is differentiated from traditional credit cards as these assignments are created and paid for on a per-transaction basis, and can also be done for debit accounts and other type of transaction accounts that do not utilize credit. Additional information regarding issuer-funded installments can be found in application Ser. No. 15/147,261, entitled “Method and System for Facilitating Installments in an Electronic Transaction,” by DeSilva et al., filed on May 5, 2016, which is herein incorporated by reference in its entirety.

However, there are currently no systems in place for handling a refund for a transaction where an issuer-funded installment was created. In current systems, if a consumer returns a product to a merchant for a refund for a transaction where the issuer had created an issuer-funded installment for the consumer, the merchant will return the full amount of the refund to the issuer, who then automatically credits the consumer's account with the full amount using standard business processes. The consumer will continue to pay the remaining installment payments as usual. As such, there is no system in place to enable the consumer to have the refund applied to their installment such that the installment can be paid off in advance through the refund.

Thus, there is a need for a technical solution where ongoing issuer-funded installments may be refunded through the refund of a payment transaction with a merchant using the same transaction account.

### SUMMARY

The present disclosure provides a description of systems and methods for the processing of refunds for ongoing installment transactions. When a refund is processed that is associated with a transaction for which an issuer-funded installment was created, the refund is flagged to indicate as much, automatically providing a communication to the consumer with the opportunity to have the refund applied to ongoing installments on the account. The consumer can communicate which installment(s) have been selected that the refund may be applied to, including other issuer-funded installments that were created for other transactions, even apart from the one subject to the refund, which may be particularly beneficial in cases where the refund is for a greater amount than the remaining amount to be paid via the installments. The result is that installments may be cleared more quickly, providing the consumer with greater credit, where applicable, and purchasing power, which is a benefit to both the consumer and the issuing institution. In addition, having installments cleared immediately as a result of a refund can lead to repayment of installments faster and more efficiently than traditional systems, where a consumer may receive a refund and have to manually pay for issuer-funded installments in advance, if their issuer even provides such capability. Some or all of these potential advantages may be achieved through the technological system described below.

A method for processing refunds for ongoing installment transactions includes: storing, in an account database of a processing server, an account profile, wherein the account profile is a structured data set related to a transaction account including at least an account number and a current balance; storing, in an installment database of the processing server, a plurality of installment profiles, wherein each installment profile is a structured data set related to an installment transaction including at least the account number and a remaining balance; receiving, by a receiving device of the processing server, a transaction message electronically transmitted via a payment network, wherein the transaction message is formatted based on one or more standards and includes at least a message type indicator indicative of a refund and a plurality of data elements, where a first data element includes the account number, a second data element includes a refund amount, and a third data element includes a flag indicating the refund is for an installment transaction; executing, by a querying module of the processing server, a query on the installment database to update the remaining balance in at least one installment profile of the plurality of installment profiles, wherein a difference between a combination of the remaining balance and the updated remaining balance for each of the at least one installment profile is less than or equal to the refund amount; and executing, by the querying module of the processing server, a query on the account database to update the current balance in the account profile by increasing the current balance when the refund amount is greater than the difference between the combination of the remaining balance and the updated remaining balance for each of the at least one installment profile.

A system for processing refunds for ongoing installment transactions includes: an account database of a processing server configured to store an account profile, wherein the account profile is a structured data set related to a transaction account including at least an account number and a current balance; an installment database of the processing server configured to store a plurality of installment profiles, wherein each installment profile is a structured data set related to an installment transaction including at least the account number and a remaining balance; a receiving device of the processing server configured to receive a transaction message electronically transmitted via a payment network, wherein the transaction message is formatted based on one or more standards and includes at least a message type indicator indicative of a refund and a plurality of data elements, where a first data element includes the account number, a second data element includes a refund amount, and a third data element includes a flag indicating the refund is for an installment transaction; and a querying module of the processing server configured to execute a query on the installment database to update the remaining balance in at least one installment profile of the plurality of installment profiles, wherein a difference between a combination of the remaining balance and the updated remaining balance for each of the at least one installment profile is less than or equal to the refund amount, and execute a query on the account database to update the current balance in the account profile by increasing the current balance when the refund amount is greater than the difference between the combination of the remaining balance and the updated remaining balance for each of the at least one installment profile.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high level system architecture for processing refunds for issuer-funded installments in accordance with exemplary embodiments.

FIG. 2 is a block diagram illustrating the processing server of the system of FIG. 1 for the processing of refunds for ongoing issuer-funded installments in accordance with exemplary embodiments.

FIG. 3 is a flow diagram illustrating an example process for refunding ongoing issuer-funded installments in the system of FIG. 1 in accordance with exemplary embodiments.

FIG. 4 is a flow chart illustrating an exemplary method for processing refunds for ongoing installment transactions in accordance with exemplary embodiments.

FIG. 5 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Glossary of Terms

Payment Network—A system or network used for the transfer of money via the use of cash-substitutes for thousands, millions, and even billions of transactions during a given period. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, transaction accounts, etc. Examples of networks or systems configured to perform as payment networks include those operated by MasterCard®, VISA®, Discover®, American Express®, PayPal®, etc. Use of the term “payment network” herein may refer to both the payment network as an entity, and the physical payment network, such as the equipment, hardware, and software comprising the payment network.

Payment Rails—Infrastructure associated with a payment network used in the processing of payment transactions and the communication of transaction messages and other similar data between the payment network and other entities interconnected with the payment network that handles thousands, millions, and even billions of transactions during a given period. The payment rails may be comprised of the hardware used to establish the payment network and the interconnections between the payment network and other associated entities, such as financial institutions, gateway processors, etc. In some instances, payment rails may also be affected by software, such as via special programming of the communication hardware and devices that comprise the payment rails. For example, the payment rails may include specifically configured computing devices that are specially configured for the routing of transaction messages, which may be specially formatted data messages that are electronically transmitted via the payment rails, as discussed in more detail below.

Transaction Account—A financial account that may be used to fund a transaction, such as a checking account, savings account, credit account, virtual payment account, etc. A transaction account may be associated with a consumer, which may be any suitable type of entity associated with a payment account, which may include a person, family, company, corporation, governmental entity, etc. In some instances, a transaction account may be virtual, such as those accounts operated by PayPal®, etc.

Merchant—An entity that provides products (e.g., goods and/or services) for purchase by another entity, such as a consumer or another merchant. A merchant may be a consumer, a retailer, a wholesaler, a manufacturer, or any other type of entity that may provide products for purchase as will be apparent to persons having skill in the relevant art. In some instances, a merchant may have special knowledge in the goods and/or services provided for purchase. In other instances, a merchant may not have or require any special knowledge in offered products. In some embodiments, an entity involved in a single transaction may be considered a merchant. In some instances, as used herein, the term “merchant” may refer to an apparatus or device of a merchant entity.

Issuer—An entity that establishes (e.g., opens) a letter or line of credit in favor of a beneficiary, and honors drafts drawn by the beneficiary against the amount specified in the letter or line of credit. In many instances, the issuer may be a bank or other financial institution authorized to open lines of credit. In some instances, any entity that may extend a line of credit to a beneficiary may be considered an issuer. The line of credit opened by the issuer may be represented in the form of a payment account, and may be drawn on by the beneficiary via the use of a payment card. An issuer may also offer additional types of payment accounts to consumers as will be apparent to persons having skill in the relevant art, such as debit accounts, prepaid accounts, electronic wallet accounts, savings accounts, checking accounts, etc., and may provide consumers with physical or non-physical means for accessing and/or utilizing such an account, such as debit cards, prepaid cards, automated teller machine cards, electronic wallets, checks, etc.

Acquirer—An entity that may process payment card transactions on behalf of a merchant. The acquirer may be a bank or other financial institution authorized to process payment card transactions on a merchant's behalf. In many instances, the acquirer may open a line of credit with the merchant acting as a beneficiary. The acquirer may exchange funds with an issuer in instances where a consumer, which may be a beneficiary to a line of credit offered by the issuer, transacts via a payment card with a merchant that is represented by the acquirer.

Payment Transaction—A transaction between two entities in which money or other financial benefit is exchanged from one entity to the other. The payment transaction may be a transfer of funds, for the purchase of goods or services, for the repayment of debt, or for any other exchange of financial benefit as will be apparent to persons having skill in the relevant art. In some instances, payment transaction may refer to transactions funded via a payment card and/or payment account, such as credit card transactions. Such payment transactions may be processed via an issuer, payment network, and acquirer. The process for processing such a payment transaction may include at least one of authorization, batching, clearing, settlement, and funding. Authorization may include the furnishing of payment details by the consumer to a merchant, the submitting of transaction details (e.g., including the payment details) from the merchant to their acquirer, and the verification of payment details with the issuer of the consumer's payment account used to fund the transaction. Batching may refer to the storing of an authorized transaction in a batch with other authorized transactions for distribution to an acquirer. Clearing may include the sending of batched transactions from the acquirer to a payment network for processing. Settlement may include the debiting of the issuer by the payment network for transactions involving beneficiaries of the issuer. In some instances, the issuer may pay the acquirer via the payment network. In other instances, the issuer may pay the acquirer directly. Funding may include payment to the merchant from the acquirer for the payment transactions that have been cleared and settled. It will be apparent to persons having skill in the relevant art that the order and/or categorization of the steps discussed above performed as part of payment transaction processing.

### System for Processing Refunds for Ongoing Issuer-Funded Installments

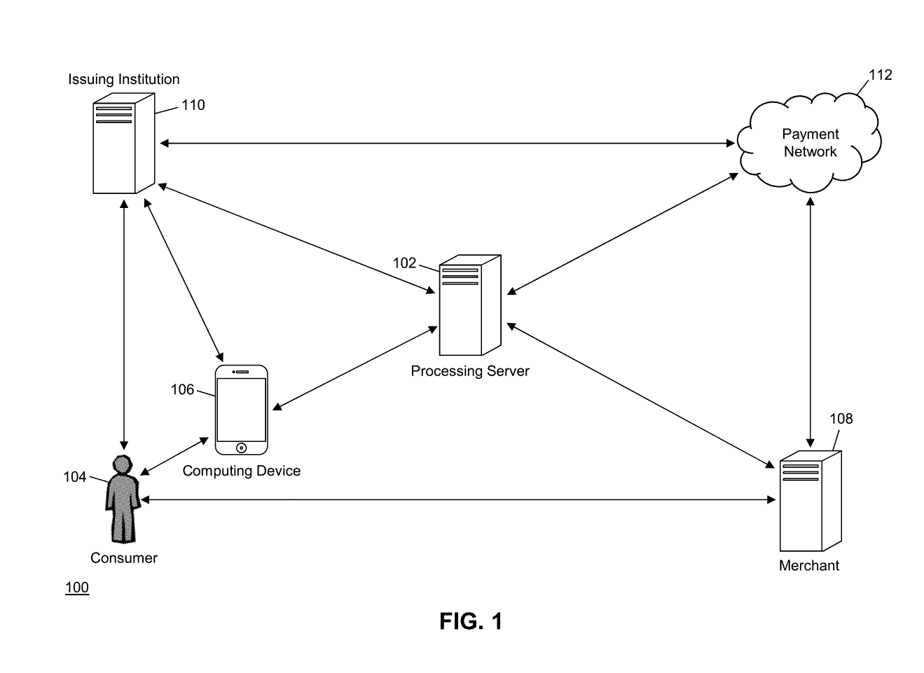

FIG. 1 illustrates a system 100 for the processing of refunds for ongoing issuer-funded installments through the refunding of merchant transactions that may be applied to any ongoing issuer-funded installment on the same transaction account.

The system 100 may include a processing server 102. The processing server 102, discussed in more detail below, may be configured to process refunds for merchant transactions that are applied to ongoing issuer-funded installments for the repayment thereof. In the system 100, a consumer 104 may engage in a payment transaction with a merchant 108. The consumer 104 may have a transaction account issued thereto by an issuing institution 110, which may be a financial institution, such as an issuing bank, or other suitable type of entity configured to issue transaction accounts for use in funding payment transactions. The consumer 104 may use the transaction account to fund the payment transaction that is conducted with the merchant 108, such as by providing payment credentials, including a primary account number, to the merchant 108 that includes the payment credentials in a transaction message generated for the payment transaction that is submitted to a payment network 112 via payment rails associated therewith and processed accordingly using traditional methods and systems.

The payment transaction may be processed traditionally, whereby the issuing institution 110 may fund the payment transaction by paying the transaction amount to the merchant 108 either directly or indirectly (e.g., to an acquiring institution associated with the merchant 108, which may then credit the merchant 108 accordingly). In the system 100, the issuing institution 110 may communicate with the consumer 104 to create an issuer-funded installment for the transaction with the merchant 108. As discussed herein, issuer-funded installments may be transactions where the issuing institution 110 funds the original payment transaction with the merchant 108 (also referred to herein as the “merchant transaction”), where the consumer 104 pays the issuing institution 110 back over time through a number of installment payments, often scheduled at recurring intervals over a predetermined period of time. In many cases, additional fees and/or interest will be incurred such that the consumer 104 pays the issuing institution 110 a greater amount than the initial transaction amount as a benefit for offering the installment. In some cases, the issuing institution 110 may take a lien on the product(s) purchased via the original merchant transaction.

In the system 100, the consumer 104 may request a refund from the merchant 108 for the original merchant transaction. The merchant 108 may submit a transaction message to the payment network 112 via payment rails associated therewith that includes data indicating the transaction to be a refund of a prior processed transaction, which may be consistent with traditional refund processing by the merchant 108. The payment network 112 may process the refund using traditional methods and systems, such as by contacting the issuing institution 110, verifying the transaction and original payment to the merchant 108 (e.g., or merchant's acquiring institution) and facilitating repayment from the merchant 108 (e.g., or acquiring institution) to the issuing institution 110. The transaction message for the refund may be forwarded to the processing server 102, either directly from the payment network 112 or by the issuing institution 110. In some embodiments, the processing server 102 may be a part of the issuing institution 110. In such embodiments, the payment network 112 may flag the transaction message as corresponding to a payment transaction where an issuer-funded installment was created. In such cases, the payment network 112 may be informed by the issuing institution 110 and/or processing server 102 when an issuer-funded installment is created. In other embodiments, the issuing institution 110 may receive the transaction message from the payment network 112 and may insert a flag into the transaction message prior to forwarding of the transaction message to the processing server 102. The flagging of the payment transaction may indicate to the issuing institution 110 (e.g., or processing server 102, as applicable) to not initially credit the consumer's transaction account when processing the refund, so as to prevent double payment.

In an exemplary embodiment, the transaction message may be compliant with one or more standards governing the exchange of financial transaction message, such as the International Organization of Standardization's ISO 8583 or ISO 20022 standards. In such embodiments, the transaction message may include a plurality of data elements, where each data element may be configured to store data as set forth in the applicable standard(s). In the system 100, the transaction message for the refund may include a flag in one of the data elements that indicates that the transaction message is related to a refund for a merchant transaction for which an issuer-funded installment was created. In some cases, the data element may be a data element that, according to the applicable standard(s), is reserved for private use. The processing server 102 may receive the transaction message and may identify one or more installments to be paid via the refund.

In one embodiment, the consumer 104 may provide instructions as to the installment(s) to be paid. In such embodiments, the consumer 104 may possess a computing device 106 that may be used to communicate which installments are to be funded using the refund. The computing device 106 may be any type of computing device suitable for performing the functions discussed herein, such as a desktop computer, laptop computer, notebook computer, tablet computer, cellular phone, smart phone, smart watch, smart television, wearable computing device, implantable computing device, etc. The computing device 106 may communicate with external computing systems (e.g., the processing server 102, issuing institution 110, etc.) using any suitable communication network and method, such as via a web page, application program, application programming interface, e-mail, short messaging service, multimedia messaging service, etc.

In one such embodiment, the consumer 104 may directly indicate which installment(s) to fund to the processing server 102, such as by submitting a message to the processing server 102 via the computing device 106. In another such embodiment, the consumer 104 may use the computing device 106 to communicate the data to the issuing institution 110, which may forward the selected installment(s) to the processing server 102 (e.g., in a data element in the forward transaction message or an accompanying data message). In yet another embodiment, the consumer 104 may communicate which installment(s) to be funded to the merchant 108, which may include the information in a data element in the transaction message submitted for the refund. In an exemplary embodiment, each issuer-funded installment held between the issuing institution 110 and the consumer 104 may have a unique identification value associated therewith, referred to herein as an “installment identifier.” In such embodiments, the installment identifier for each installment to be funded via the refund may be provided to the processing server 102.

The processing server 102 may receive the installment identifier(s) for the installment(s) that are to be funded. The processing server 102 may then update an installment record for each installment to update the remaining balance accordingly, where the installment record may be stored locally in the processing server 102 or externally, such as in a database of the issuing institution 110. In cases where an installment is completely funded via the refund amount, any remaining amount may be applied to additional installments, if identified, or may be used to credit the transaction account involved in the installment transaction. In some cases, the consumer 104 may indicate a priority order for funding of the installments. For example, the consumer 104 may have two ongoing issuer-funded installments: installment A with a remaining balance of $300 and installment B with a remaining balance of $500. The consumer 104 may receive a refund from the merchant 108 for $400 and may indicate they want it to be applied to installments A and B, with A having priority. The refund will thus be applied to the transaction account by paying off installment A entirely, and paying off $100 of the remaining $500 balance for installment B. In some cases, the issuing institution 110 may decide how to modify an installment where a balance still remains following the application of the refund, such as by modifying the number of installment payments or periodic installment amount. In other cases, the consumer 104 may request how to modify an installment when selecting the installment(s) to which the refund is to be applied.

As a result, the refund for the original merchant transaction may be used to satisfy any outstanding installment payments for any ongoing issuer-funded installment. In some cases, the consumer 104 may request that the refund initially be applied to the issuer-funded installment created for the now-refunded merchant transaction. In such cases, the refund may be applied accordingly by the issuing institution 110 and/or processing server 102, as applicable. In some embodiments, the transaction message for the refund may include a transaction identifier or other unique value that identifies the original merchant transaction. In some such embodiments, the issuing institution 110 or processing server 102 may automatically apply the refund to the corresponding issuer-funded installment (e.g., identified via the transaction identifier), where any excess may be automatically credited to the transaction account or applied to other ongoing installments as selected by the consumer 104.

In some embodiments, the consumer 104 may select installments to be funded prior to the issuing of the refund for the original merchant transaction. For instance, the consumer 104 may have a list of ongoing issuer-funded installments with an ordering selected for funding via refunds before any refund occurs. In another example, when the consumer 104 visits the merchant 108 for the refund, the consumer 104 may preemptively select the installment(s) to which it will apply before the refund is processed, where such a selection may be applicable for the next refund. In some cases, the processing server 102 may, once the transaction message has been received that is flagged as being related to an issuer-funded installment, request selection of one or more installments by the consumer 104, such as by electronically transmitting a request to the computing device 106 associated with the transaction account. The consumer 104 may then make their selections, which may be communicated to the processing server 102 for processing accordingly.

The methods and systems discussed herein provide for the application of a refund for a merchant transaction to one or more ongoing issuer-funded installments. The application of the refund may ensure that the consumer 104 receives their refund, but that it can also be applied quickly and efficiently to an ongoing installment transaction. In addition, the system 100 is designed such that a refund can be applied to any ongoing installment transaction at the issuing institution 110, providing for greater control and repayment by consumers 104. Furthermore, by selecting the installment transaction(s) at the time of the refund, or prior, repayments of installment transactions may occur more quickly and more efficiently than in traditional systems, which may benefit both consumers 104 and issuing institutions 110 by reducing processing times, system resource expenditure, and making more money available to consumers 104 for future use of their transaction account. The flag that is included in transaction messages communicated for the refund can also ensure that the refund is processed traditionally between the merchant 108, issuing institution 110, and acquiring institutions or other entities, without the consumer's transaction account being unfairly credited. As such, the system 100 may be implemented on legacy merchant systems, without requiring any modifications by merchants 108 or acquiring institutions, thus assisting in adoption of the processes discussed herein.

### Processing Server

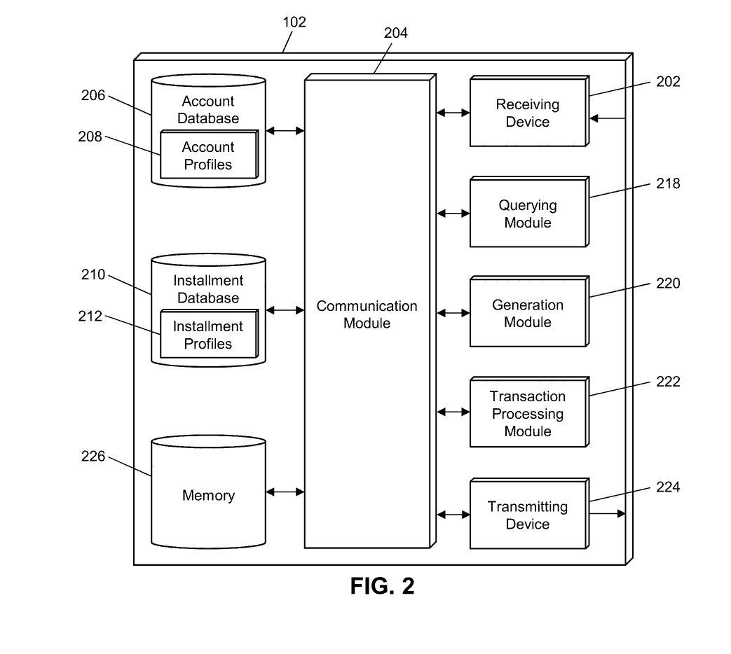

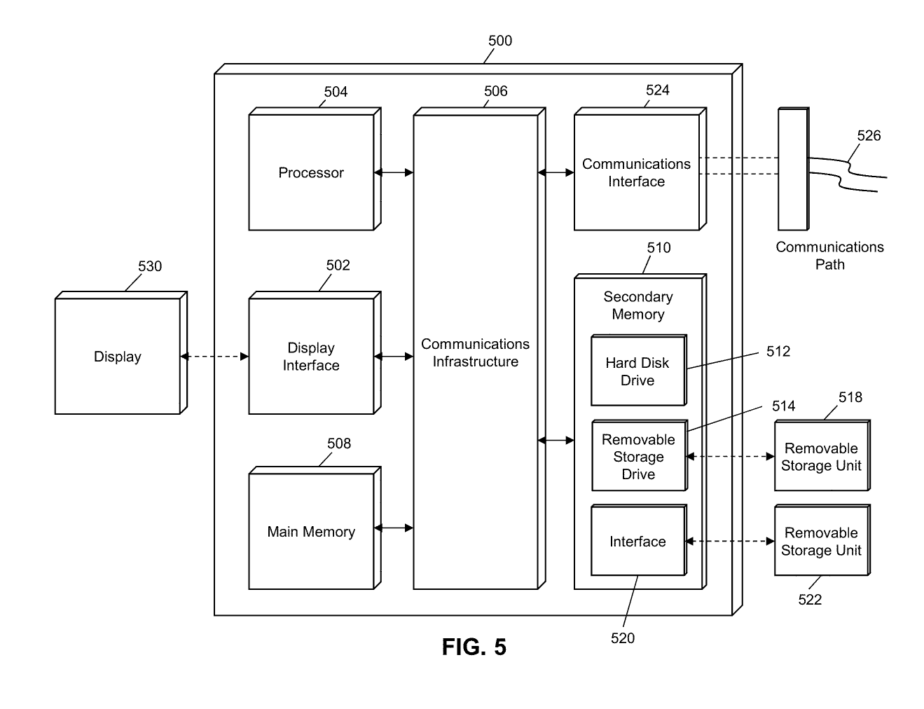

FIG. 2 illustrates an embodiment of a processing server 102 in the system 100. It will be apparent to persons having skill in the relevant art that the embodiment of the processing server 102 illustrated in FIG. 2 is provided as illustration only and may not be exhaustive to all possible configurations of the processing server 102 suitable for performing the functions as discussed herein. For example, the computer system 500 illustrated in FIG. 5 and discussed in more detail below may be a suitable configuration of the processing server 102.

The processing server 102 may include a receiving device 202. The receiving device 202 may be configured to receive data over one or more networks via one or more network protocols. In some instances, the receiving device 202 may be configured to receive data from computing devices 106, merchants 108, issuing institutions 110, payment networks 112, and other systems and entities via one or more communication methods, such as radio frequency, local area networks, wireless area networks, cellular communication networks, Bluetooth, the Internet, etc. In some embodiments, the receiving device 202 may be comprised of multiple devices, such as different receiving devices for receiving data over different networks, such as a first receiving device for receiving data over a local area network and a second receiving device for receiving data via the Internet. The receiving device 202 may receive electronically transmitted data signals, where data may be superimposed or otherwise encoded on the data signal and decoded, parsed, read, or otherwise obtained via receipt of the data signal by the receiving device 202. In some instances, the receiving device 202 may include a parsing module for parsing the received data signal to obtain the data superimposed thereon. For example, the receiving device 202 may include a parser program configured to receive and transform the received data signal into usable input for the functions performed by the processing device to carry out the methods and systems described herein.

The receiving device 202 may be configured to receive data signals electronically transmitted by issuing institutions 110 that are superimposed or otherwise encoded with installment data, such as installment identifiers, remaining balances, corresponding account numbers, installment payment information, etc., and other account data, such as account balances. The receiving device 202 may also be configured to receive data signals superimposed or otherwise encoded with transaction messages for refunds, which may be electronically transmitted by issuing institutions 110 or payment networks 112. The receiving device 202 may be further configured to receive data signals that are superimposed or otherwise encoded with one or more installment identifiers as selected by the consumer 104 for application of a refund thereto, which may be electronically transmitted by the computing device 106, merchant 108, issuing institution 110, or payment network 112, and may be included in a transaction message for a refund or a separate data message, which, in some cases, may accompany the transaction message.

The processing server 102 may also include a communication module 204. The communication module 204 may be configured to transmit data between modules, engines, databases, memories, and other components of the processing server 102 for use in performing the functions discussed herein. The communication module 204 may be comprised of one or more communication types and utilize various communication methods for communications within a computing device. For example, the communication module 204 may be comprised of a bus, contact pin connectors, wires, etc. In some embodiments, the communication module 204 may also be configured to communicate between internal components of the processing server 102 and external components of the processing server 102, such as externally connected databases, display devices, input devices, etc. The processing server 102 may also include a processing device. The processing device may be configured to perform the functions of the processing server 102 discussed herein as will be apparent to persons having skill in the relevant art. In some embodiments, the processing device may include and/or be comprised of a plurality of engines and/or modules specially configured to perform one or more functions of the processing device, such as a querying module 218, generation module 220, transaction processing module 222, etc. As used herein, the term “module” may be software or hardware particularly programmed to receive an input, perform one or more processes using the input, and provides an output. The input, output, and processes performed by various modules will be apparent to one skilled in the art based upon the present disclosure.

The processing server 102 may include an account database 206. The account database 206 may be configured to store a plurality of account profiles 208 using a suitable data storage format and schema. The account database 206 may be a relational database that utilizes structured query language for the storage, identification, modifying, updating, accessing, etc. of structured data sets stored therein. Each account profile 208 may be a structured data set configured to store data related to a transaction account that is used to fund payment transactions that is eligible for use with issuer-funded installments. An account profile 208 may include at least an account number and a current balance. In some cases, an account profile 208 may include installment identifiers associated with issuer-funded installments that are currently outstanding for the transaction account. In some cases, an account profile 208 may include transaction identifiers and/or other transaction data associated with payment transactions funded via the related transaction account.

The processing server 102 may also include an installment database 210. The installment database 210 may be configured to store a plurality of installment profiles 212 using a suitable data storage format and schema. The installment database 210 may be a relational database that utilizes structured query language for the storage, identification, modifying, updating, accessing, etc. of structured data sets stored therein. Each installment profile 212 may be a structured data set configured to store data related to an issuer-funded installment. The installment profile 212 may include at least an account number corresponding to the transaction account to which the installment applies and a remaining balance. In some cases, an installment profile 212 may also include an installment identifier or any other identifying information. An installment profile 212 may also include additional data associated with the installment for use in processing thereof, such as installment terms, installment periods, installment amounts, fee or interest data, etc. In some cases, an installment profile 212 may include a transaction identifier associated with the original merchant transaction from which the installment was created.

The processing server 102 may include a querying module 218. The querying module 218 may be configured to execute queries on databases to identify information. The querying module 218 may receive one or more data values or query strings, and may execute a query string based thereon on an indicated database, such as the account database 206, to identify information stored therein. The querying module 218 may then output the identified information to an appropriate engine or module of the processing server 102 as necessary. The querying module 218 may, for example, execute a query on the account database 206 to identify an account profile 208 associated with an installment or to update the account balance in an account profile 208 following receipt of a refund and payment of an installment. In another example, the querying module 218 may execute a query on the installment database 210 to identify an installment profile 212 for updating of a balance associated therewith based on receipt of a refund for a payment transaction to be applied thereto.

The processing server 102 may also include a generation module 220. The generation module 220 may be configured to generate data for use by the processing server 102 in performing the functions discussed herein. The generation module 220 may receive an instruction, may generate data based on that instruction, and may output the generated data to another module or engine of the processing server 102. For example, the generation module 220 may be configured to generate data messages, such as a request message to be transmitted to a computing device 106 requesting selection of one or more installments for payment via a refund. In instances where the processing server 102 is a part of the issuing institution 110, the generation module 220 may be configured to generate installment plans for use as issuer-funded installments for a processed merchant transaction.

The processing server 102 may also include a transaction processing module 222. The transaction processing module 222 may be configured to perform functions associated with the processing of payment transactions as part of the functions of the processing server 102 as discussed herein. For instance, the transaction processing module 222 may be configured to parse transaction messages, initiate payments from one transaction account to another, approve or deny payment transactions, process credits or debits on transaction accounts, etc. In cases where the processing server 102 is a part of the issuing institution 110, the transaction processing module 222 may be configured to perform the traditional functions of an issuing institution with respect to the processing of payment transactions and refunds thereof.

The processing server 102 may also include a transmitting device 224. The transmitting device 224 may be configured to transmit data over one or more networks via one or more network protocols. In some instances, the transmitting device 224 may be configured to transmit data to computing devices 106, issuing institutions 110, payment networks 112, and other entities via one or more communication methods, local area networks, wireless area networks, cellular communication, Bluetooth, radio frequency, the Internet, etc. In some embodiments, the transmitting device 224 may be comprised of multiple devices, such as different transmitting devices for transmitting data over different networks, such as a first transmitting device for transmitting data over a local area network and a second transmitting device for transmitting data via the Internet. The transmitting device 224 may electronically transmit data signals that have data superimposed that may be parsed by a receiving computing device. In some instances, the transmitting device 224 may include one or more modules for superimposing, encoding, or otherwise formatting data into data signals suitable for transmission.

The transmitting device 224 may be configured to electronically transmit data signals to computing devices 106, which may be superimposed or otherwise encoded with requests for selection of installment transactions for application of a refund thereto. The transmitting device 224 may also be configured to electronically transmit data signals to issuing institutions 110, which may be superimposed or otherwise encoded with transaction messages associated with refunds or data associated with the management and repayment of installments, such as requests for modification to installment records or transaction account balances based on repayment thereof. The transmitting device 224 may also be configured to electronically transmit data signals superimposed or otherwise encoded with transaction messages to the payment network 112 via payment rails associated therewith for use in the processing of payment transactions and refunds using traditional methods.

The processing server 102 may also include a memory 226. The memory 226 may be configured to store data for use by the processing server 102 in performing the functions discussed herein, such as public and private keys, symmetric keys, etc. The memory 226 may be configured to store data using suitable data formatting methods and schema and may be any suitable type of memory, such as read-only memory, random access memory, etc. The memory 226 may include, for example, encryption keys and algorithms, communication protocols and standards, data formatting standards and protocols, program code for modules and application programs of the processing device, and other data that may be suitable for use by the processing server 102 in the performance of the functions disclosed herein as will be apparent to persons having skill in the relevant art. In some embodiments, the memory 226 may be comprised of or may otherwise include a relational database that utilizes structured query language for the storage, identification, modifying, updating, accessing, etc. of structured data sets stored therein. The memory 226 may be configured to store, for example, installment calculation terms, repayment priority rules, etc.

### Process for Application of Refunds to Ongoing Installments

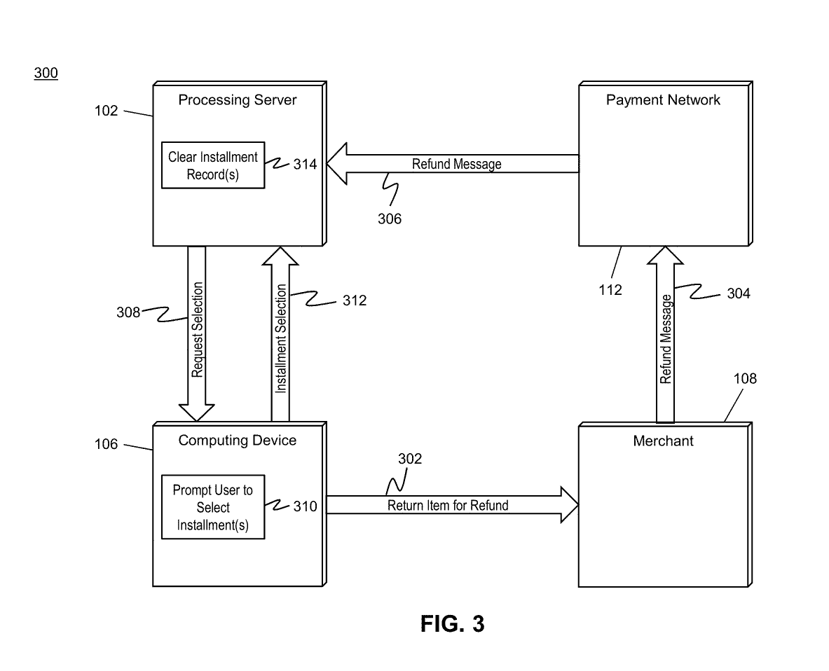

FIG. 3 illustrates a process 300 of an example implementation in the system 100 of the application of a refund of a merchant transaction to one or more ongoing issuer-funded installments.

In step 302, the consumer 104 associated with the computing device 106 may return a product to the merchant 108 for a refund associated with a merchant transaction for which an issuer-funded installment was created. In step 304, the merchant 108 may generate and submit a transaction message to the payment network 112 via payment rails associated therewith that requests a refund be made on the original merchant transaction. The transaction message may include at least one data element that includes the primary account number associated with the transaction account used to fund the original merchant transaction. The payment network 112 may, in step 306, insert a flag into a data element of the transaction message reserved in an applicable standard for private use that indicates that the transaction message corresponds to an original merchant transaction for which an issuer-funded installment was created and forward the flagged transaction message to the processing server 102 using the payment rails or an alternative, suitable communication network. In some embodiments, the transaction message may be first transmitted to the issuing institution 110, which may forward the message on through to the processing server 102. In some such cases, the issuing institution 110 may identify installments eligible for payment via the refund, which may be provided to the processing server 102 for presentation to the consumer 104 via the computing device 106, as discussed below.

In step 308, the transmitting device 224 of the processing server 102 may electronically transmit a data request (e.g., generated by the generation module 220 of the processing server 102) to the computing device 106 requesting selection of one or more installments for application of the refund thereto, where the computing device 106 may be identified in an account profile 208 related to the transaction account use to fund the original merchant transaction as identified via the primary account number included in the received transaction message. In some instances, the data request may include installment identifiers and other installment data (e.g., remaining balance, repayment date, interest rate, etc.) for each ongoing installment, such as may be identified by the processing server 102 in the installment database 210 based on the account identifier or other data included in the identified account profile 208. In cases where the issuing institution 110 forwarded the transaction message to the processing server 102, such data may be identified by the issuing institution 110 and provided thereby. In step 310, the computing device 106 may prompt the consumer 104 to select one or more ongoing installments for application of the refund thereto.

The consumer 104 may select one or more installments via a suitable input device interfaced with the computing device 106. In step 312, the computing device 106 may electronically transmit the consumer selection of one or more installment identifiers to the processing server 102 using a suitable communication network and method for receipt by the receiving device 202 thereof. In step 314, the querying module 218 of the processing server 102 may execute one or more queries on the installment database 210 of the processing server 102 to update the account balance of the selected installment(s) based on the refund amount and remaining balance of the installment. In instances where an installment may be entirely repaid, the querying module 218 may clear the installment profile 212 or otherwise indicate in the installment profile 212 that repayment was successfully completed. In cases where every selected installment may be repaid without all of the refund amount being used, the querying module 218 may execute a query on the account database 206 to update the account balance included in the account profile 208 related to the transaction account to credit the account with the remaining amount.

### Exemplary Method for Processing Refunds for Ongoing Installment Transactions

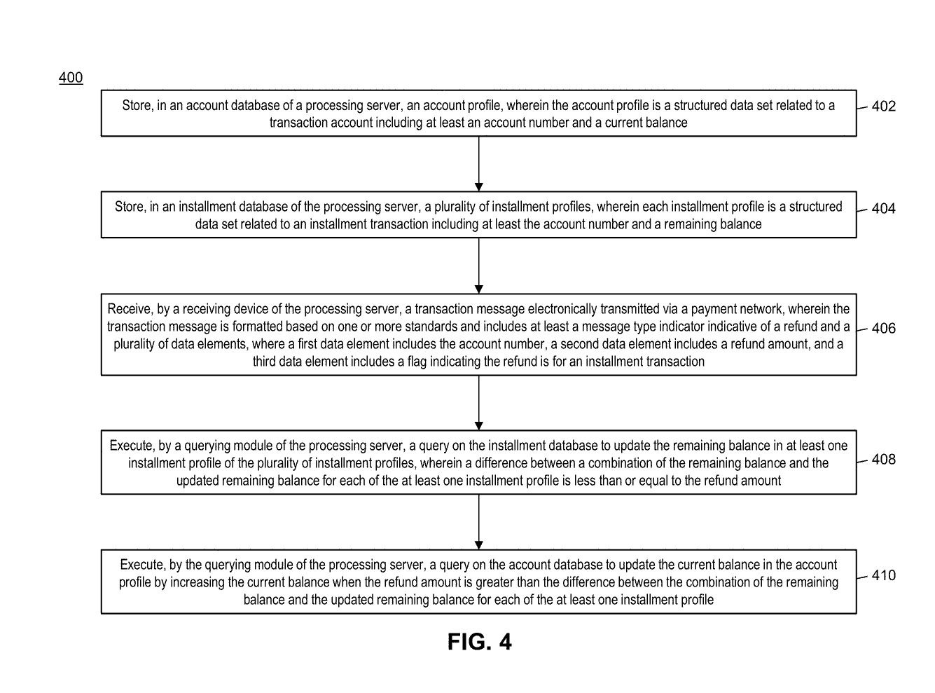

FIG. 4 illustrates a method 400 for the processing of a refund to be applied to one or more ongoing issuer-funded installments associated with the same transaction account involved in the refund.

In step 402, an account profile (e.g., an account profile 208) may be stored in an account database (e.g., the account database 206) of a processing server (e.g., the processing server 102), wherein the account profile is a structured data set related to a transaction account including at least an account number and a current balance. In step 404, a plurality of installment profiles (e.g., installment profiles 212) may be stored in an installment database (e.g., the installment database 210) of the processing server, wherein each installment profile is a structured data set related to an installment transaction including at least the account number and a remaining balance. In step 406, a transaction message electronically transmitted via a payment network (e.g., the payment network 112) may be received by a receiving device (e.g., the receiving device 202) of the processing server, wherein the transaction message is formatted based on one or more standards and includes at least a message type indicator indicative of a refund and a plurality of data elements, where a first data element includes the account number, a second data element includes a refund amount, and a third data element includes a flag indicating the refund is for an installment transaction.

In step 408, a query may be executed on the installment database by a querying module (e.g., the querying module 218) of the processing server to update the remaining balance in at least one installment profile of the plurality of installment profiles, wherein a difference between a combination of the remaining balance and the updated remaining balance for each of the at least one installment profile is less than or equal to the refund amount. In step 410, a query may be executed by the querying module of the processing server on the account database to update the current balance in the account profile by increasing the current balance if the refund amount is greater than the difference between the combination of the remaining balance and the updated remaining balance for each of the at least one installment profile.

In one embodiment, the third data element may be a data element reserved for private use according to the one or more standards. In some embodiments, each installment profile may further include an installment identifier. In a further embodiment, the plurality of data elements included in the transaction message may include at least one data element configured to store one or more installment identifiers, and each of the at least one installment profiles may include one of the one or more installment identifiers. In another further embodiment, the method 400 may further include receiving, by the receiving device of the processing server, a data message separate from the transaction message, wherein the data message includes one or more installment identifiers, and each of the at least one installment profiles includes one of the one or more installment identifiers. In an even further embodiment, the data message may be received from the payment network. In another even further embodiment, the method 400 may also include electronically transmitting, by a transmitting device (e.g., the transmitting device 224) of the processing server, a request message to a computing device (e.g., the computing device 106) associated with the account profile, wherein the received data message is received from the computing device in response to the transmitted request message. In yet another even further embodiment, the received data message may further include a priority order for the one or more installment identifiers, and the remaining balance may be updated in each of the at least one installment profile based on the priority order.

### Computer System Architecture

FIG. 5 illustrates a computer system 500 in which embodiments of the present disclosure, or portions thereof, may be implemented as computer-readable code. For example, the processing server 102 of FIG. 1 may be implemented in the computer system 500 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3 and 4.

If programmable logic is used, such logic may execute on a commercially available processing platform configured by executable software code to become a specific purpose computer or a special purpose device (e.g., programmable logic array, application-specific integrated circuit, etc.). A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 518, a removable storage unit 522, and a hard disk installed in hard disk drive 512.

Various embodiments of the present disclosure are described in terms of this example computer system 500. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 504 may be a special purpose or a general purpose processor device specifically configured to perform the functions discussed herein. The processor device 504 may be connected to a communications infrastructure 506, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 500 may also include a main memory 508 (e.g., random access memory, read-only memory, etc.), and may also include a secondary memory 510. The secondary memory 510 may include the hard disk drive 512 and a removable storage drive 514, such as a floppy disk drive, a magnetic tape drive, an optical disk drive, a flash memory, etc.

The removable storage drive 514 may read from and/or write to the removable storage unit 518 in a well-known manner. The removable storage unit 518 may include a removable storage media that may be read by and written to by the removable storage drive 514. For example, if the removable storage drive 514 is a floppy disk drive or universal serial bus port, the removable storage unit 518 may be a floppy disk or portable flash drive, respectively. In one embodiment, the removable storage unit 518 may be non-transitory computer readable recording media.

In some embodiments, the secondary memory 510 may include alternative means for allowing computer programs or other instructions to be loaded into the computer system 500, for example, the removable storage unit 522 and an interface 520. Examples of such means may include a program cartridge and cartridge interface (e.g., as found in video game systems), a removable memory chip (e.g., EEPROM, PROM, etc.) and associated socket, and other removable storage units 522 and interfaces 520 as will be apparent to persons having skill in the relevant art.

Data stored in the computer system 500 (e.g., in the main memory 508 and/or the secondary memory 510) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 500 may also include a communications interface 524. The communications interface 524 may be configured to allow software and data to be transferred between the computer system 500 and external devices. Exemplary communications interfaces 524 may include a modem, a network interface (e.g., an Ethernet card), a communications port, a PCMCIA slot and card, etc. Software and data transferred via the communications interface 524 may be in the form of signals, which may be electronic, electromagnetic, optical, or other signals as will be apparent to persons having skill in the relevant art. The signals may travel via a communications path 526, which may be configured to carry the signals and may be implemented using wire, cable, fiber optics, a phone line, a cellular phone link, a radio frequency link, etc.

The computer system 500 may further include a display interface 502. The display interface 502 may be configured to allow data to be transferred between the computer system 500 and external display 530. Exemplary display interfaces 502 may include high-definition multimedia interface (HDMI), digital visual interface (DVI), video graphics array (VGA), etc. The display 530 may be any suitable type of display for displaying data transmitted via the display interface 502 of the computer system 500, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 508 and secondary memory 510, which may be memory semiconductors (e.g., DRAMs, etc.). These computer program products may be means for providing software to the computer system 500. Computer programs (e.g., computer control logic) may be stored in the main memory 508 and/or the secondary memory 510. Computer programs may also be received via the communications interface 524. Such computer programs, when executed, may enable computer system 500 to implement the present methods as discussed herein. In particular, the computer programs, when executed, may enable processor device 504 to implement the methods illustrated by FIGS. 3 and 4, as discussed herein. Accordingly, such computer programs may represent controllers of the computer system 500. Where the present disclosure is implemented using software, the software may be stored in a computer program product and loaded into the computer system 500 using the removable storage drive 514, interface 520, and hard disk drive 512, or communications interface 524.

The processor device 504 may comprise one or more modules or engines configured to perform the functions of the computer system 500. Each of the modules or engines may be implemented using hardware and, in some instances, may also utilize software, such as corresponding to program code and/or programs stored in the main memory 508 or secondary memory 510. In such instances, program code may be compiled by the processor device 504 (e.g., by a compiling module or engine) prior to execution by the hardware of the computer system 500. For example, the program code may be source code written in a programming language that is translated into a lower level language, such as assembly language or machine code, for execution by the processor device 504 and/or any additional hardware components of the computer system 500. The process of compiling may include the use of lexical analysis, preprocessing, parsing, semantic analysis, syntax-directed translation, code generation, code optimization, and any other techniques that may be suitable for translation of program code into a lower level language suitable for controlling the computer system 500 to perform the functions disclosed herein. It will be apparent to persons having skill in the relevant art that such processes result in the computer system 500 being a specially configured computer system 500 uniquely programmed to perform the functions discussed above.

Techniques consistent with the present disclosure provide, among other features, systems and methods for processing refunds for ongoing installment transactions. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for processing refunds for ongoing installment transactions, comprising:
storing, in an account database of a processing server, an account profile, wherein the account profile is a structured data set related to a transaction account including at least an account number and a current balance;
storing, in an installment database of the processing server, a plurality of installment profiles, wherein each installment profile is a structured data set related to an installment transaction including at least the account number and a remaining balance;
receiving, by a receiving device of the processing server, a transaction message electronically transmitted via a payment network, wherein the transaction message is formatted based on one or more standards and includes at least a message type indicator indicative of a refund and a plurality of data elements, where a first data element includes the account number, a second data element includes a refund amount, and a third data element includes a flag indicating the refund is for an installment transaction;
executing, by a querying module of the processing server, a query on the installment database to update the remaining balance in at least one installment profile of the plurality of installment profiles, wherein a difference between a combination of the remaining balance and the updated remaining balance for each of the at least one installment profile is less than or equal to the refund amount; and
executing, by the querying module of the processing server, a query on the account database to update the current balance in the account profile by increasing the current balance when the refund amount is greater than the difference between the combination of the remaining balance and the updated remaining balance for each of the at least one installment profile.

2. The method of claim 1, wherein the third data element is a data element reserved for private use according to the one or more standards.

3. The method of claim 1, wherein each installment profile further includes an installment identifier.

4. The method of claim 3, wherein
the plurality of data elements included in the transaction message includes at least one data element configured to store one or more installment identifiers, and
each of the at least one installment profiles includes one of the one or more installment identifiers.

5. The method of claim 3, further comprising:
receiving, by the receiving device of the processing server, a data message separate from the transaction message, wherein
the data message includes one or more installment identifiers, and
each of the at least one installment profiles includes one of the one or more installment identifiers.

6. The method of claim 5, wherein the data message is received from the payment network.

7. The method of claim 5, further comprising:
electronically transmitting, by a transmitting device of the processing server, a request message to a computing device associated with the account profile, wherein
the received data message is received from the computing device in response to the transmitted request message.

8. The method of claim 5, wherein
the received data message further includes a priority order for the one or more installment identifiers, and
the remaining balance is updated in each of the at least one installment profile based on the priority order.

9. A system for processing refunds for ongoing installment transactions, comprising:
an account database of a processing server configured to store an account profile, wherein the account profile is a structured data set related to a transaction account including at least an account number and a current balance;
an installment database of the processing server configured to store a plurality of installment profiles, wherein each installment profile is a structured data set related to an installment transaction including at least the account number and a remaining balance;
a receiving device of the processing server configured to receive a transaction message electronically transmitted via a payment network, wherein the transaction message is formatted based on one or more standards and includes at least a message type indicator indicative of a refund and a plurality of data elements, where a first data element includes the account number, a second data element includes a refund amount, and a third data element includes a flag indicating the refund is for an installment transaction; and
a querying module of the processing server configured to
execute a query on the installment database to update the remaining balance in at least one installment profile of the plurality of installment profiles, wherein a difference between a combination of the remaining balance and the updated remaining balance for each of the at least one installment profile is less than or equal to the refund amount, and
execute a query on the account database to update the current balance in the account profile by increasing the current balance when the refund amount is greater than the difference between the combination of the remaining balance and the updated remaining balance for each of the at least one installment profile.

10. The system of claim 9, wherein the third data element is a data element reserved for private use according to the one or more standards.

11. The system of claim 9, wherein each installment profile further includes an installment identifier.

12. The system of claim 11, wherein
the plurality of data elements included in the transaction message includes at least one data element configured to store one or more installment identifiers, and
each of the at least one installment profiles includes one of the one or more installment identifiers.

13. The system of claim 11, wherein
the receiving device of the processing server is further configured to receive a data message separate from the transaction message,
the data message includes one or more installment identifiers, and
each of the at least one installment profiles includes one of the one or more installment identifiers.

14. The system of claim 13, wherein the data message is received from the payment network.

15. The system of claim 13, further comprising:
a transmitting device of the processing server configured to electronically transmit a request message to a computing device associated with the account profile, wherein
the received data message is received from the computing device in response to the transmitted request message.

16. The system of claim 13, wherein
the received data message further includes a priority order for the one or more installment identifiers, and
the remaining balance is updated in each of the at least one installment profile based on the priority order.
